(19) United States
(12) Patent Application Publication
(10) Pub. No.: US 2008/0047893 A1
(43) Pub. Date: Feb. 28, 2008

(54) FILTER AND METHOD OF MAKING

(76) Inventors: Weston H. Gerwin, Perrysburg, OH (US); Michael S. Lynch, Fostoria, OH (US); Christopher R. Reamsnyder, Perrysburg, OH (US); Donald W. Baldwin, Perrysburg, OH (US); Eric J. Schramm, Port Clinton, OH (US)

Correspondence Address: CANTOR COLBURN, LLP, 20 Church Street, 22nd Floor, Hartford, CT, 06103, US

(21) Appl. No.: 11/845,042

(22) Filed: Aug. 25, 2007

Related U.S. Application Data
(60) Provisional application No. 60/823,601, filed on Aug. 25, 2006.
(60) Provisional application No. 60/840,219, filed on Aug. 25, 2006.

(51) Int. Cl. B01D 35/30

(52) U.S. Cl. 210/342

(57) ABSTRACT

A fluid filter, comprising: a housing defining an inner cavity; an end plate secured to the housing, the end plate having a plurality of inlet openings and at least one outlet opening; an end disk disposed within the housing, the end disk having portions in a spaced relationship with respect to the end plate and an interior surface of the housing; a filtration media disposed within the housing and secured to the end disk, the filtration media comprising a first layer of filtration media, the first layer of filtration media being thermoformed to have a plurality of channels with an upper surface and a lower surface; a second layer of filtration media, the second layer of filtration media being secured to the lower surface of the first layer to form a plurality of inlet openings at one end of the first and second layers of filtration media and a sealed outlet disposed at another end of the first and second layers of filtration media, the another end comprising a substantially flat configuration; and a strip of adhesive disposed on the upper surface of the first layer, wherein the second layer is secured to the first layer by the strip of adhesive as the first and second layers are wrapped about each other and the filtration media is disposed in a fluid filtration path from the inlet openings to the at least one outlet opening, the fluid filtration path being defined by the end plate, the end disk, the housing and the filtration media.

### CROSS REFERENCE TO RELATED APPLICATIONS

The present application claims the benefit of U.S. Provisional Patent Applications, Ser. Nos. 60/823,601 filed Aug. 25, 2006 and 60/840,219 filed Aug. 25, 2006, the contents each of which are incorporated herein by reference thereto.

### BACKGROUND

The present invention relates to a filter for a fluid and a method for making the same.

Liquid filters are provided to remove contaminants from a fluid being circulated through a flow path. Non-limiting examples, include oil, fuel and coolant filters, wherein the filter is configured to have a flow path therethrough, wherein the filter has an inlet opening or openings and an outlet opening with filtration media disposed therein.

In general a filter comprises a housing for the filtration media as well as a means for defining the flow path wherein fluid to be filtered enters into the filter passes through the filter media and then the filtered fluid exits out through an outlet opening. As may be expected, a filter may comprise multiple components to ensure the fluid being filtered passes through the media and out through the outlet opening.

Accordingly, it is desirable to provide a filter and method of manufacture wherein the filter is capable of providing an improved means for filtering a fluid while also simplifying the filter design.

### SUMMARY OF THE INVENTION

A filter and method of making is provided. Exemplary embodiments are directed to a filter, comprising: a housing defining an inner cavity; an end plate secured to the housing, the end plate having a plurality of inlet openings and at least one outlet opening; an end disk disposed within the housing, the end disk having portions in a spaced relationship with respect to the end plate and an interior surface of the housing; a filtration media disposed within the housing and secured to the end disk, the filtration media comprising a first layer of filtration media, the first layer of filtration media being thermoformed to have a plurality of channels with an upper surface and a lower surface; a second layer of filtration media, the second layer of filtration media being secured to the lower surface of the first layer to form a plurality of inlet openings at one end of the first and second layers of filtration media and a sealed outlet disposed at another end of the first and second layers of filtration media, the another end comprising a substantially flat configuration; and a strip of adhesive disposed on the upper surface of the first layer, wherein the second layer is secured to the first layer by the strip of adhesive as the first and second layers are wrapped about each other and the filtration media is disposed in a fluid filtration path from the inlet openings to the at least one outlet opening, the fluid filtration path being defined by the end plate, the end disk, the housing and the filtration media.

In another exemplary embodiment a filter and method of making is provided. The filter comprising: a housing defining an inner cavity; an end plate secured to the housing, the end plate having a plurality of inlet openings and at least one outlet opening; an inner sleeve disposed within the housing, the inner sleeve having portions in a spaced relationship with respect to the end plate and an interior surface of the housing; a plurality of tab members extending away from the inner sleeve, the tab members contacting a portion of the housing and defining a fluid path between the interior surface of the housing and an interior area of the inner sleeve, the interior area being in fluid communication with the at least one outlet opening; a filtration media disposed within the interior area of the inner sleeve, wherein a fluid filtration path from the inlet openings to the at least one outlet opening is defined by the inner sleeve and the filtration media is disposed in the fluid filtration path.

In another exemplary embodiment a filter and method of making is provided. The filter comprising: a housing defining an inner cavity; an inner sleeve disposed within the inner cavity, the inner sleeve having portions in a spaced relationship with respect to an interior surface of the housing; a plurality of tab members extending away from the inner sleeve, the tab members contacting a portion of the housing and defining a fluid path between the interior surface of the housing and an interior area of the inner sleeve, the interior area being in fluid communication with at least one outlet opening of the inner sleeve; and a filtration media disposed within the interior area of the inner sleeve, wherein a fluid filtration path to the at least one outlet opening is defined by the inner sleeve and the filtration media is disposed in the inner sleeve.

The above-described and other features are appreciated and understood by those skilled in the art from the following detailed description, drawings, and appended claims.

### DESCRIPTION OF THE DRAWINGS

FIG. 1 is a perspective cross-section view of a filter constructed in accordance with an exemplary embodiment of the present invention;

FIG. 2 is a cross sectional view of filter media used in an exemplary embodiment of the present invention;

FIG. 3 is a view along lines 3-3 of FIG. 2;

FIG. 4 is a perspective view of a portion of the media in accordance with an exemplary embodiment of the present invention;

FIGS. 5-10 illustrate construction of a filter media for use in exemplary embodiments of the present invention;

FIG. 11 is a perspective cross-section view of a filter constructed in accordance with an alternative exemplary embodiment of the present invention;

FIG. 12 is another perspective cross-section view of a filter constructed in accordance with an alternative exemplary embodiment of the present invention;

FIG. 13 is a perspective cross-section view of a filter constructed in accordance with still another alternative exemplary embodiment of the present invention;

FIGS. 14-16 are views of portions of the filter illustrated in FIG. 13; and

FIGS. 17-19 are views of portions of the filter illustrated in FIG. 11.

### DETAILED DESCRIPTION OF EXEMPLARY EMBODIMENTS

In accordance with exemplary embodiments of the present invention, a filter and method of making a filter is disclosed. In an exemplary embodiment the filter will comprise an outer housing and an end plate secured to the outer housing, the end plate being configured to have a plurality of inlet openings and at least one outlet opening, wherein a fluid path therethrough is defined and filter media is disposed in the fluid path.

In one non-limiting exemplary embodiment, the filter media comprises a plurality of layers of media formed by a pair of non-woven materials secured to each other wherein one of the non-woven materials is formed to have a plurality of corrugations and the other is a planar member welded to the layer having a plurality of corrugations and thereafter the two layers are wrapped around each other in order to provide a larger amount of filter surface area. Non-limiting examples of non-woven media include but are not limited to synthetic and cellulose based non-woven medias.

Reference is made to the following U.S. Pat. Nos. 6,673,136; 5,820,646; 4,410,427; and 4,589,983, the contents of which are incorporated herein by reference thereto.

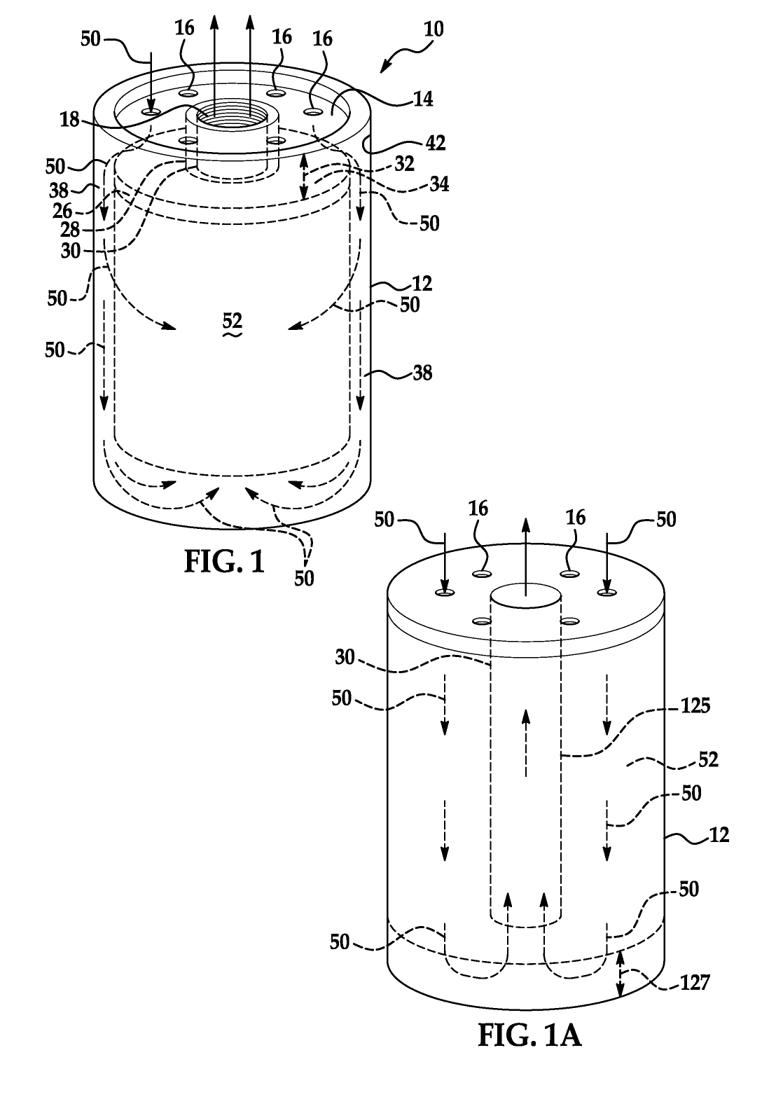

Referring to FIG. 1, a cross sectional view of a filter 10 constructed in accordance with an exemplary embodiment is illustrated. It being understood that filter 10 can be used with any fluid (e.g., oil, gas, fuel diesel or otherwise, coolants, water etc.) and that the filter illustrated is but one of may filter configurations contemplated in accordance with exemplary embodiments of the present invention.

As illustrated filter 10 comprises a housing 12 having an end plate 14 secured to one end of the housing. End plate 14 has a plurality of inlet openings 16 and at least one outlet opening 18. As illustrated outlet opening 18 is configured to threadingly engage a threaded spud with a plurality of threads disposed in an inner surface of the outlet opening.

In accordance with an exemplary embodiment and secured to a portion 24 of the end plate is an end disk collector 26. End disk collector 26 is configured to have a neck portion 28 fluidly sealed to an outer periphery 30 of the outlet opening. In accordance with an exemplary embodiment, neck portion has a length sufficient to define a gap 32 between a shield portion 34 of the end disk collector and a portion of the end plate, which includes the inlet openings.

Depending away from shield portion 34 is a wall portion 36, which in an exemplary embodiment defines a fluid path 38 between an outer surface of the wall portion and an inner surface 42 of the housing.

Accordingly, a fluid path defined by arrows 50 is provided. As shown, a fluid enters the filter through the inlet openings passes though gaps 32 and 38 and a filter media 52 secured to the end disk collector.

Accordingly, the end disk collector and the filter media are configured to provide a flow path through the filter wherein fluid entering through openings 16 must be filtered by the media before exiting through opening 18.

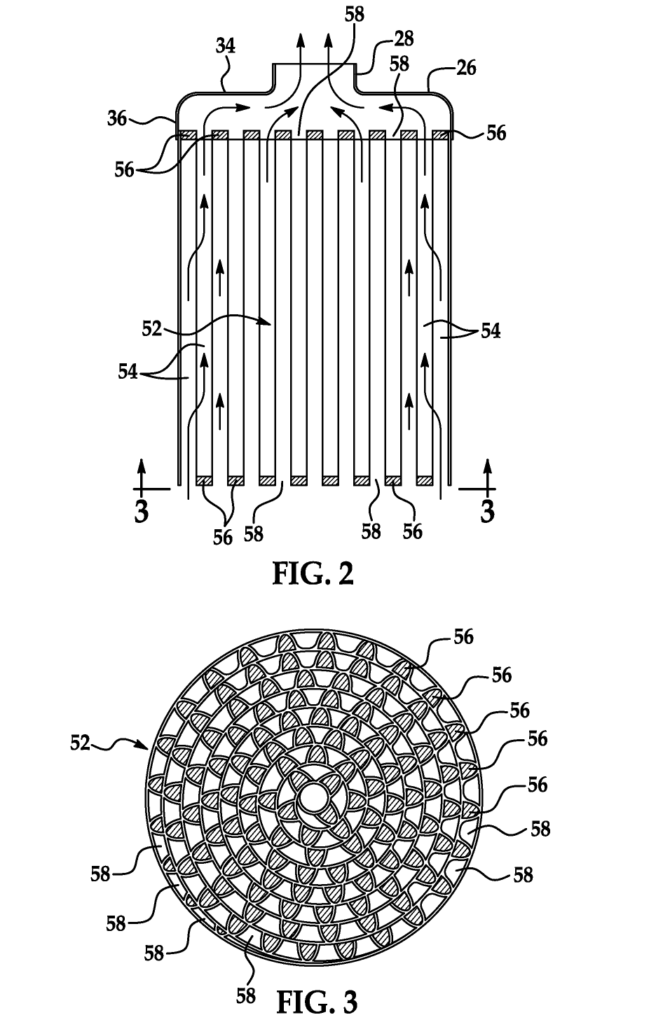

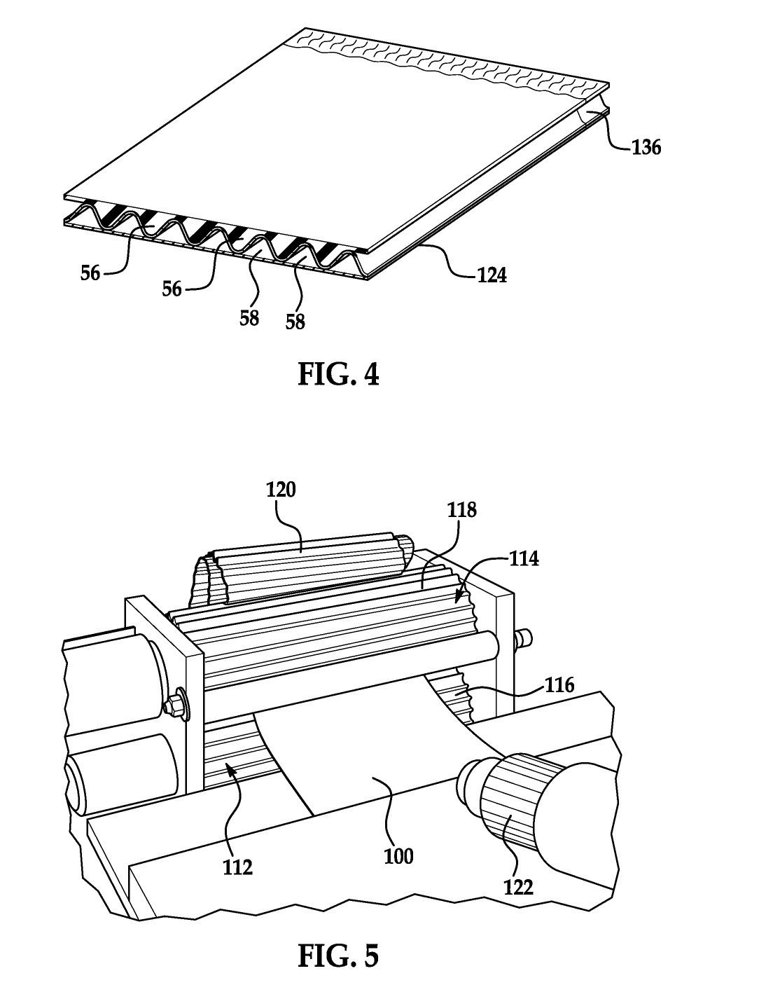

FIG. 2 illustrates the end disk collector and the filter media. FIG. 3 illustrates an end view of the filter media. As shown the filter, media has a plurality of passages 54 that extend along nearly the entire length of the filter, wherein each of the passages are sealed at one end and open on the other in an alternating fashion thus, fluid passing through media 52 must be filtered by at least one layer of media before exiting through one of the passage openings. This construction allows for a great amount of filter surface area thus increasing the capacity of the filter.

In one non-limiting exemplary embodiment, the filter media is formed by the teachings of U.S. provisional patent application Ser. No. 11/533,649 filed Sep. 20, 2006, the contents of which are incorporated herein by reference thereto.

In this embodiment, the media provides high contaminant capacity per packing volume available. In accordance with the teachings of the aforementioned provisional patent application, a non-woven media is used to provide a top or first sheet that is formed into a corrugated layer, and then the first sheet is attached to another flat sheet of the non-woven media and then this two sheet layer is wrapped around itself, which provides a greater amount of media that can be fitted into a given packaging space thus giving greater filtering capacity of the media.

In one non-limiting exemplary embodiment the top sheet or first sheet containing the corrugations is formed to have the corrugations by a thermoforming process of a synthetic non-woven media. Alternatively, and if a cellulose based media is used, an embossing process could be used to form the corrugations and other means of sealing the two layers may be used other than sonic welding (e.g., adhesives, hot melt adhesives, etc.). Regardless of the material used and the process for forming the corrugations the corrugations would be formed prior to the attachment of the lower or second flat sheet of media. The forming of the corrugations should be tapered gradually to pinch down to a flat portion on one side of the sheet to enable the attachment by welding of the lower flat sheet. The two sheets can be bonded together on one edge using adhesive or in an exemplary embodiment a continuous sonic weld.

Once the two sheets are attached together forming a long continuous roll of paper the media can be wrapped around itself in a spiral pattern. During this wrapping process, a bead of adhesive will be applied on the edge opposite the flat edge of the two layers in order to secure the layers to each other as well as provide a sealing means in order to provide a plurality of fluid paths wherein fluid passing therethrough is filtered by the media. By having alternative ends of the corrugations on each subsequent layer sealed, a flow path is created which utilizes the entire media area. In accordance with an exemplary embodiment, the final shape of the media could be round, elliptical, oval or any number of the regular configurations.

Referring now to FIG. 5 a flat sheet or first layer of non-woven media 100 is shown being inserted between two geared rolls 112 and 114. Each of the geared rolls have a plurality of teeth 116, 118 configured to form a plurality of channels 120 as sheet 110 as it is passed between rolls 112 and 114. Prior to sheet 110 being inserted between each of the geared rolls it is heated by for example a heat gun 122. Thus, a thermoforming process is used to form the plurality of channels as sheet 110 passes between geared rolls 112 and 114. Of course, other equivalent methods for heating sheet 110 are contemplated in accordance with exemplary embodiments of the present invention.

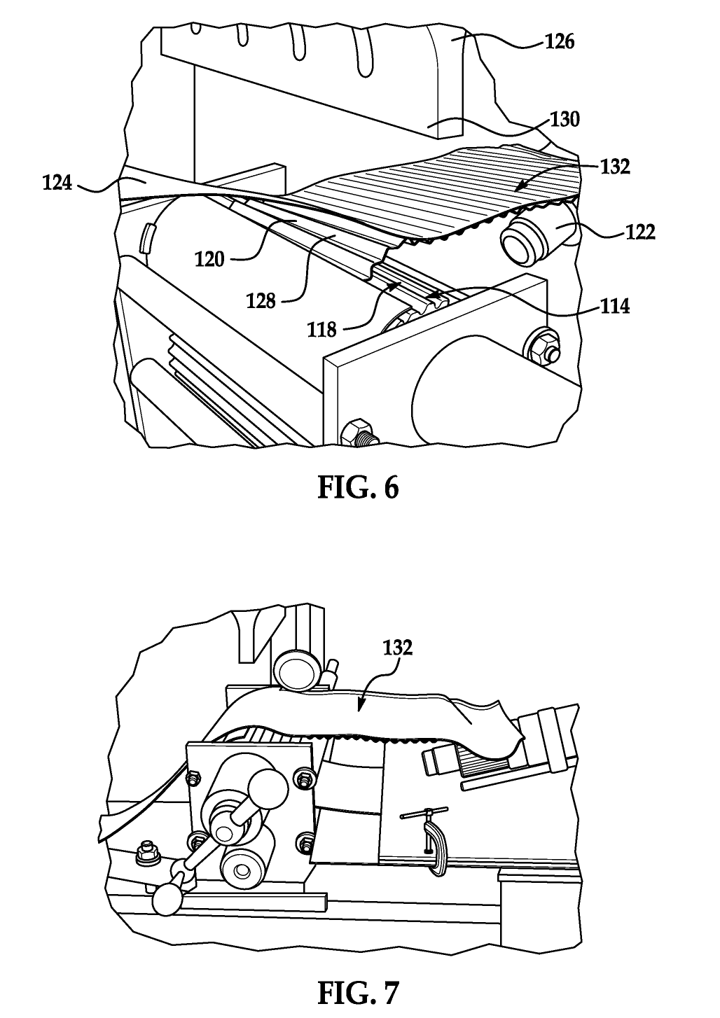

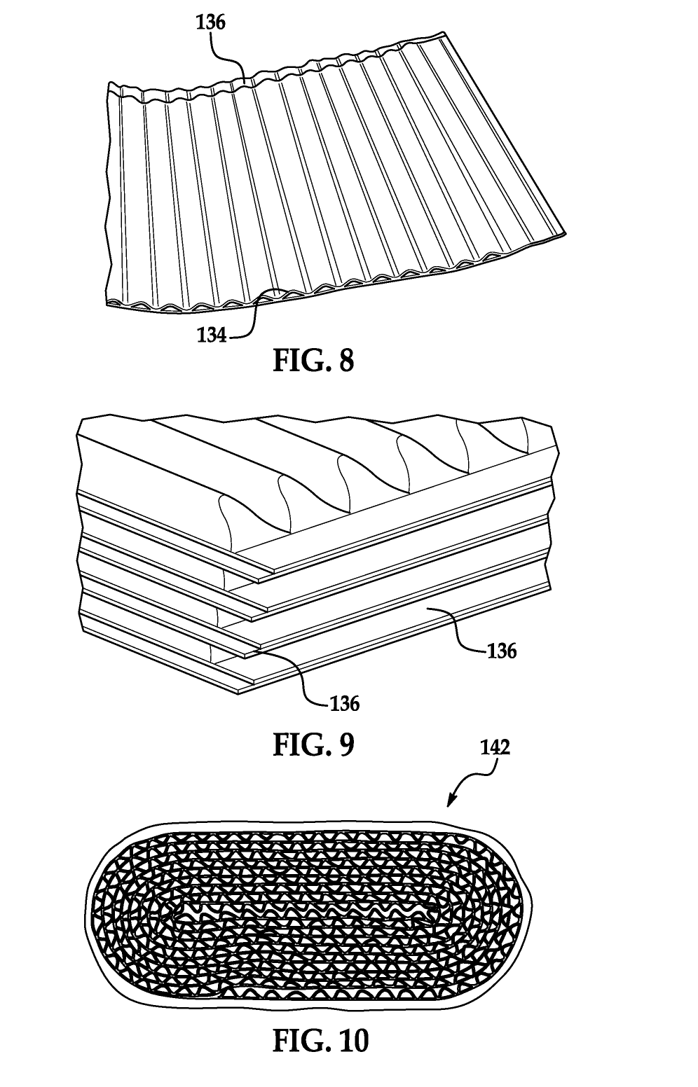

Referring now to FIGS. 5-10, the method of securing a second layer 124 of non-woven media to first layer 110 is illustrated. In accordance with an exemplary embodiment layer 110 is secured to layer 124 by ultrasonic welding, which is a process wherein two pieces of plastic or metal are joined together seamlessly through high-frequency acoustic vibrations where one component to be welded is placed upon a fixed anvil and the second component being placed on top and an extension (“horn”) connected to a transducer is lowered down onto the top component, and a very rapid (˜20,000 KHz), low-amplitude acoustic vibration is applied to the welding zone. The acoustic energy is converted into heat energy by friction, and the parts are welded together in less than a second.

In accordance with an exemplary embodiment a sonic welding horn 126 is lowered down onto second layer 124 and sonically welds a lower surface 128 of channels 120 to second layer 124 by compressing layers 110 and 124 between a contact surface 130 of welding horn 126 and the gears of roll 114.

Once first layer 110 is secured to second layer 124 a sheet of filter media 132 is formed with a plurality of channels each having an inlet flow opening 134 and a closed or outlet end 136. The closed end is also formed by sonically welding the two layers together. As illustrated in FIG. 2, the flow of fluid being filtered is illustrated by the arrows in FIG. 2. As can be seen, the media comprising the entire length of the channels is used for filtration thus a larger amount of surface area is provided. Moreover, the direction of fluid flow through the filter is substantially changed or redirected, which causes particulates entrained in the fluid stream to drop off or be captured in the channels of the filter.

In order to form the final configuration of a filter constructed in accordance with an exemplary embodiment, a strip of adhesive 138 is applied to an upper surface 140 of first layer 110 after the same has been secured to second layer 124. A non-limiting example of adhesive 138 is a rubber and epoxy sealant or any other equivalent adhesive capable of securing the layers together as well as providing a fluid barrier. Thereafter, the sheet of filter media is wrapped around itself such that second layer 124 is adhered to the adhesive disposed upon the upper surface of the first layer.

Referring now to FIG. 2, the filter media with a plurality of channels is illustrated. Here the channels are open on one side and closed on the other side thus, the media defines a plurality of longitudinal channels wherein a plurality of inlet openings are on one side and a plurality of outlet openings are on the other side thus, fluid traveling through the filter media must pass through at least one layer of filter media in order to travel from the inlet to the outlet. Non limiting examples of the fluid path are shown by the arrows in FIG. 2. Of course, the media may be constructed through the use of other methods (e.g., cast molding and equivalents thereof). One non-limiting example of cast molded media is described in U.S. Provisional Patent Application Ser. No. 60/824,128 filed Aug. 31, 2006, the contents of which are incorporated herein by reference thereto. In addition, other types of media are contemplated for use with exemplary embodiments of the present invention, as long as the media filters fluid passing therethrough without adversely affecting fluid flow through the filter.

Accordingly and in accordance with exemplary embodiments of the present invention a high capacity honeycomb style media is employed in an oil, fuel or coolant or any other type of filter wherein the filtering capacity of the filter is increased.

In another alternative exemplary embodiment and for an oil filter, the media is wrapped around a solid centertube 125 having a hollow path therethrough (e.g., open on its ends but solid walls) and then the media is sealed to the inside of the housing thus, forcing the fluid through the media to the bottom of the can/housing wherein there is gap or area 127 for the filtered fluid to pass back up through the opening on the bottom of the centertube to the outlet opening on the top of the centertube. This embodiment is illustrated in FIG. 1A.

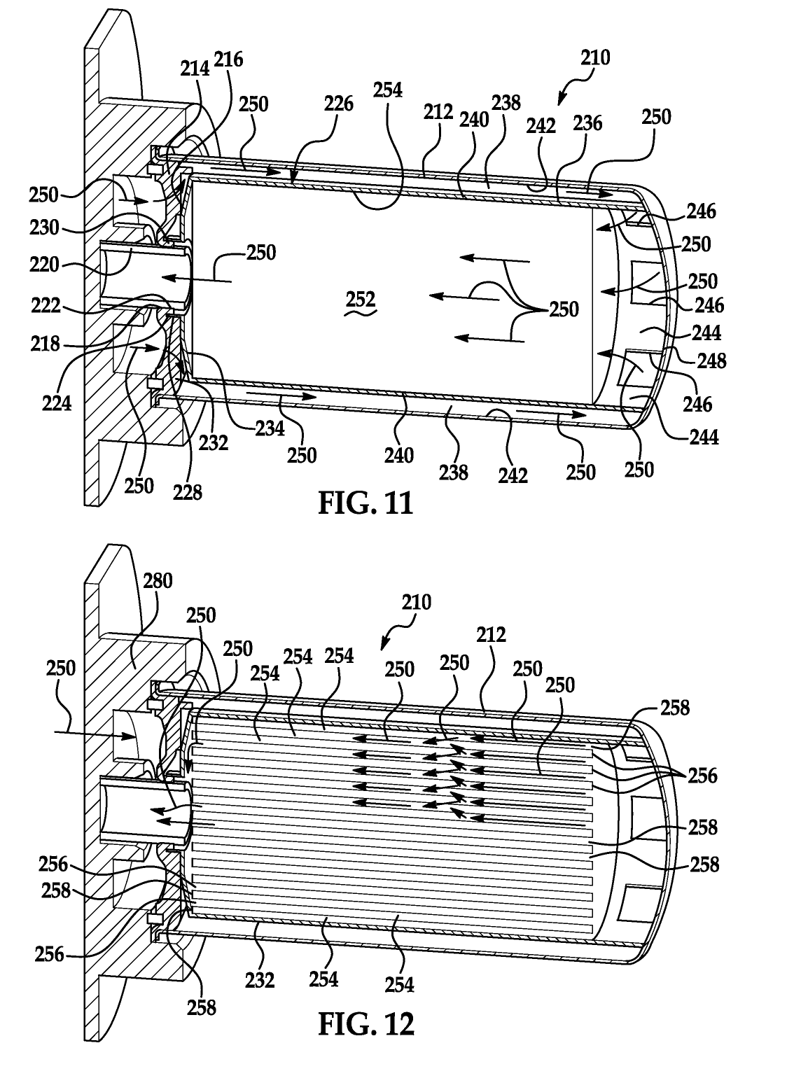

In accordance with an alternative exemplary embodiment and referring now to FIGS. 11-12 and 17-19, the filter will comprise an inner sleeve disposed within the end plate and the outer housing in a spaced relationship, the inner sleeve providing a fluid path into the at least one outlet opening through a filter media disposed within the inner sleeve. Here component parts performing similar or analogous functions are labeled in multiples of 100.

As discussed, above the filter media may comprises a plurality of layers of media formed by a layers of non-woven materials secured to each other wherein one of the non-woven materials is formed to have a plurality of corrugations and the other is a planar member welded to the layer having a plurality of corrugations and thereafter the two layers are wrapped around each other in order to provide a larger amount of filter surface area.

Referring to FIG. 11, a cross sectional view of a filter 210 constructed in accordance with an alternative exemplary embodiment is illustrated. It being understood that filter 210 can be used with any fluid (e.g., oil, gas, fuel diesel or otherwise, coolants, water etc.).

As illustrated, filter 210 comprises a housing 212 having an end plate 214 secured to one end of the housing. End plate 214 has a plurality of inlet openings 216 and at least one outlet opening 218. As illustrated, outlet opening 218 is configured to threadingly engage a threaded spud 220 with a plurality of threads 222 disposed in an inner surface of the outlet opening.

In accordance with an exemplary embodiment and secured to a portion 224 of the end plate is an inner sleeve 226. Inner sleeve 226 is configured to have a neck portion 228 fluidly sealed to an outer periphery 230 of the outlet opening. In accordance with an exemplary embodiment, neck portion has a length sufficient to define a gap 232 between a shield portion 234 of the inner sleeve and a portion of the end plate, which includes the inlet openings.

Depending away from shield portion 234 is a wall portion 236, which in an exemplary embodiment defines a fluid path 238 between an outer surface 240 of the wall portion and an inner surface 242 of the housing.

In accordance with an exemplary embodiment wall portion 236 terminates with a plurality of tab portions 244 at a distal end from the end of the inner sleeve secured to the threaded spud. In accordance with an exemplary embodiment the tab portions 244 define a plurality of openings 246 or fluid paths therethrough. In accordance with an exemplary embodiment, tabs 244 extend to and contact an end portion 248 of housing 212. Accordingly, a fluid path defined by arrows 250 is provided. As shown, a fluid enters the filter through the inlet openings passes though gaps 232 and 238, through openings 246 and into a filter media 252 disposed within an inner area 254 defined by inner sleeve 236.

Accordingly, inner sleeve defines an area for receipt of the filter media of the filter. In one non-limiting exemplary embodiment and as discussed above, the filter media is formed by the teachings of U.S. patent application Ser. No. 11/533,649 filed Sep. 20, 2006, the contents of which are incorporated herein by reference thereto.

In this embodiment, the media provides high contaminant capacity per packing volume available. In accordance with the teachings of the aforementioned provisional patent application, a non-woven media is used to provide a top or first sheet that is formed into a corrugated layer, and then the first sheet is attached to another flat sheet of the non-woven media and then this two sheet layer is wrapped around itself, which provides a greater amount of media that can be fitted into a given packaging space thus giving greater filtering capacity of the media.

In one non-limiting exemplary embodiment the top sheet or first sheet containing the corrugations is formed to have the corrugations by a thermoforming process of a synthetic non-woven media. Alternatively, and if a cellulose based media is used, an embossing process could be used to form the corrugations and other means of sealing the two layers may be used other than sonic welding (e.g., adhesives, hot melt adhesives, etc.). Regardless of the material used and the process for forming the corrugations the corrugations would be formed prior to the attachment of the lower or second flat sheet of media. The forming of the corrugations should be tapered gradually to pinch down to a flat portion on one side of the sheet to enable the attachment by welding of the lower flat sheet. The two sheets can be bonded together on one edge using adhesive or in an exemplary embodiment a continuous sonic weld.

Once the two sheets are attached together forming a long continuous roll of paper the media can be wrapped around itself in a spiral pattern. During this wrapping process, a bead of adhesive will be applied on the edge opposite the flat edge of the two layers in order to secure the layers to each other as well as provide a sealing means in order to provide a plurality of fluid paths wherein fluid passing therethrough is filtered by the media. By having alternative ends of the corrugations on each subsequent layer sealed, a flow path is created which utilizes the entire media area. In accordance with an exemplary embodiment, the final shape of the media could be round, elliptical, oval or any number of the regular configurations.

As described above, the filter media has a plurality of channels 254 wherein the channels are open or have an opening 258 on one side and closed or sealed by a sealant 256 on the other side in an alternating fashion thus, the media sealed in an alternating fashion defines a plurality of longitudinal channels wherein a plurality of inlet openings 258 are on one side and a plurality of outlet openings 258 are on the other side thus, fluid traveling through the filter media must pass through at least one layer of filter media in order to travel from the inlet to the outlet. Non limiting examples of the fluid path are shown by the arrows in FIG. 12. Of course, the media may be constructed through the use of other methods (e.g., cast molding and equivalents thereof). In addition, other types of media are contemplated for use with exemplary embodiments of the present invention, as long as the media filters fluid passing therethrough without adversely affecting fluid flow through the filter.

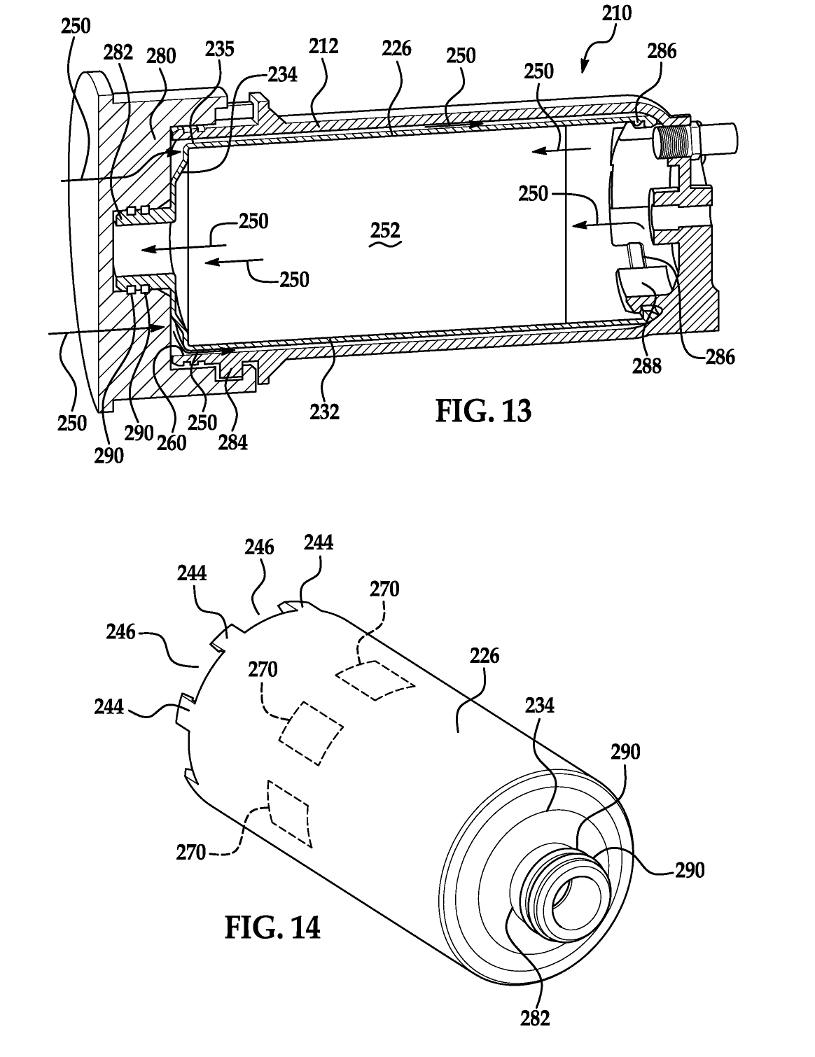

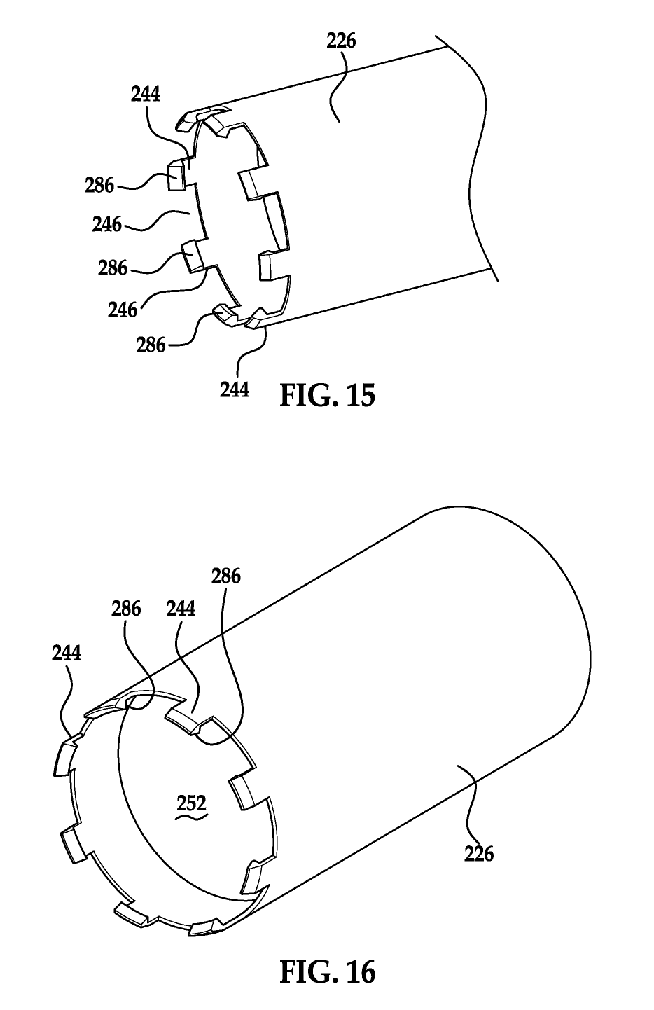

Referring now to FIGS. 13-16 an alternative exemplary embodiment of the present invention is illustrated. Here the housing 212 of the filter 210 is completely open on one end to have an opening 260 and the inner sleeve 226 and the housing 212 are configured to engage a mount or mounting flange 280 of the engine.

In accordance with an exemplary embodiment, a mounting portion 282 of the inner sleeve is received within the mounting flange 280 and a mounting portion 284 of the housing is also received within the mounting flange. In this embodiment, the neck portion or mounting portion is configured to sealingly engage the mounting flange and the housing has a feature that also engages the flange by for example a twist lock engagement thus sealing the filter to the flange wherein fluid flows into the filter, through the media and out the opening of the mounting portion.

In this embodiment, the shield portion 234 of the inner sleeve is received within the open end of the housing and a peripheral edge 235 of the shield portion defines a gap between the inner sleeve and an inner surface of the housing, the gap defining a fluid path between the inner sleeve and the inner surface of the housing.

In this embodiment, the inner sleeve and the filter media is easily inserted and removed from the housing, which provides for ease of replacement of the filter media. Accordingly, only the inner sleeve and the filter media is replaced, wherein the housing is reusable. Alternatively, the inner sleeve is also reusable in the event the filter media is capable of being removed and replaced from the inner sleeve. Also, the tab members of the inner sleeve are configured to have features 286 configured to engage features 288 of the housing thus providing a “snap-fit” engagement of the inner sleeve to the housing.

In one embodiment, mounting portion 282 has a pair of O-rings 290 that provide a means for sealing mounting portion 282 to flange 280. Likewise, the housing may also have a sealing feature such as O-rings or other equivalent members to provide a fluid seal between the housing and the flange. As in the embodiment of FIGS. 11-12, the fluid flow is still through flange 280 into the housing around the inner sleeve through the openings 246, through the media 252 and out through the neck portion 282 thus providing filtered fluid back into the flange. It being understood that the cross sectional views of may not completely show all of the fluid paths through the flange to an engine, system or other item requiring fluid filtration as well as the filter of exemplary embodiments of the present invention.

FIGS. 14-16 illustrate the inner sleeve contemplated for use with the embodiment of FIG. 13. As illustrated, the inner sleeve has a plurality of tabs members 244 each configured to have a feature 286 configured to engage a complimentary feature 288 of the housing thus, providing a “snap fit” engagement between the housing and the inner sleeve. In addition, the tab members 244 define a plurality of openings 246, which define a flow path into inner sleeve 226 and the media disposed therein.

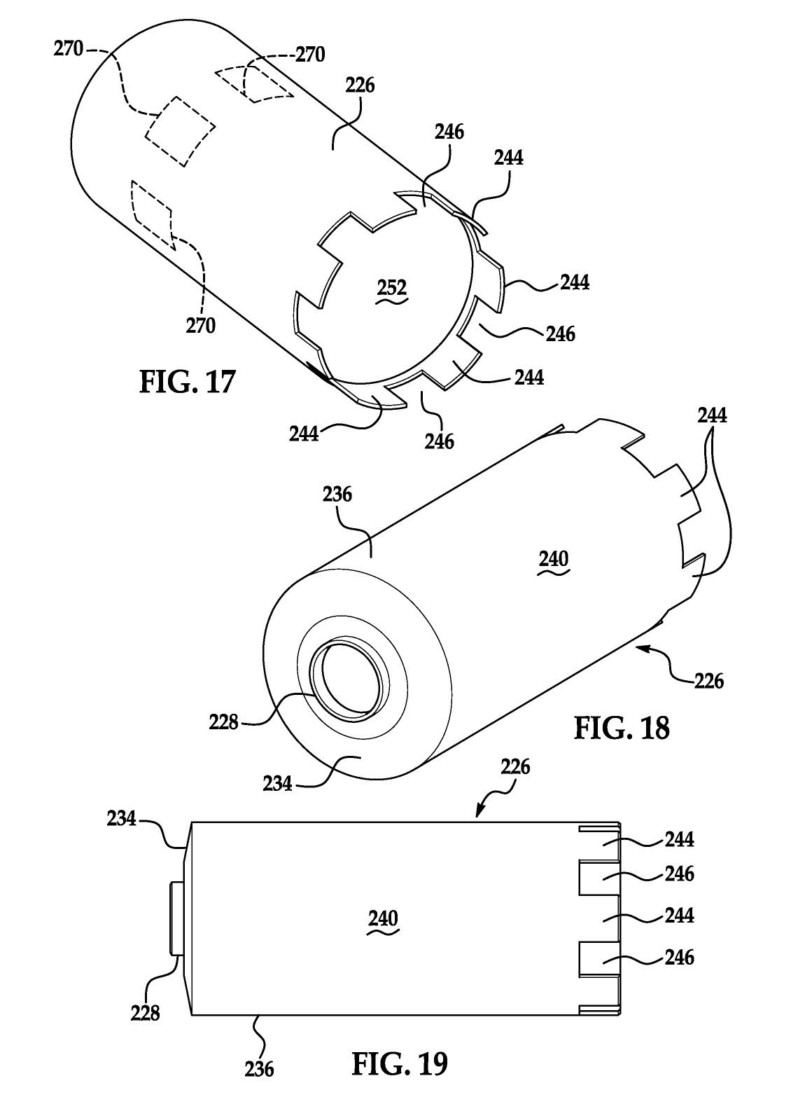

In an alternative exemplary embodiment and as illustrated in FIGS. 14 and 17 the filter media 252 comprises a non-honeycomb filtration media or typical cellulose or non-cellulose filtration media disposed in the inner sleeve and the inner sleeve comprises a plurality of openings or windows 270 in addition to or as an alternative to the tab members 244 to provide additional fluid paths into the filtration media through the inner sleeve.

FIGS. 17-19 illustrate the inner sleeve contemplated for use with the FIG. 11 embodiment.

Accordingly and in accordance with exemplary embodiments of the present invention the inner sleeve of FIGS. 11-19 defines an area for receipt of the filter media of the filter, wherein the inner sleeve also defines the flow path through the filter and the filter media. Exemplary embodiments of the present invention provide a means to house/contain filtration media and potentially eliminate other components used in typical filter designs. Exemplary embodiments of the present invention can be utilized in a number of filtration formats including spin on style and cartridge style filters.

The inner sleeve serves as a means with which to house/contain filtration media, preferably a high capacity honeycomb style media. Of course, other types of media are contemplated to be within the scope of exemplary embodiments of the present invention. Additional functions include: direct flow from the filter inlet through the media and funneling to the outlet; potentially eliminate other components such as retainer springs, filter cartridges end disks, center tubes, necessary spacers, grommets etc.

The inner sleeve itself can be a machined, molded or formed from a material that will provide reasonable structural strength and ease of manufacture, one non-limiting example is a plastic (e.g., nylon 6-6).

Inside the inner sleeve filtration media can be housed/contained such that an effective seal is created between the clean and dirty side of the filtration media which will allow the fluid to flow through the media. This seal may be accomplished in a number of ways including adhesives disposed between the media and the inner sleeve, infrared (IR) type welds or other welds and over molding of the sleeve about the filtration media.

While the invention has been described with reference to one or more exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A fluid filter, comprising:
a housing defining an inner cavity;
an end plate secured to the housing, the end plate having a plurality of inlet openings and at least one outlet opening;
an end disk disposed within the housing, the end disk having portions in a spaced relationship with respect to the end plate and an interior surface of the housing; and
a filtration media disposed within the housing and secured to the end disk, the filtration media comprising a first layer of filtration media, the first layer of filtration media being thermoformed to have a plurality of channels with an upper surface and a lower surface; a second layer of filtration media, the second layer of filtration media being secured to the lower surface of the first layer to form a plurality of inlet openings at one end of the first and second layers of filtration media and a sealed outlet disposed at another end of the first and second layers of filtration media, the another end comprising a substantially flat configuration; and a strip of adhesive disposed on the upper surface of the first layer, wherein the second layer is secured to the first layer by the strip of adhesive as the first and second layers are wrapped about each other and the filtration media is disposed in a fluid filtration path from the inlet openings to the at least one outlet opening, the fluid filtration path being defined by the end plate, the end disk, the housing and the filtration media.

2. The fluid filter as in claim 1, wherein the end disk is secured to the filtration media at one end and the other end of the filtration media is in a spaced relationship with respect to the housing of the filter and wherein fluid flowing into the inlet openings and out the at least one outlet opening must pass through the filtration media.

3. The fluid filter as in claim 1, wherein the end disk is only secured to an end portion of the filtration media and other portions of the filtration media are in a facing spaced relationship with respect to an inner surface of the housing.

4. The fluid filter as in claim 1, wherein the end disk is configured to have a neck portion fluidly sealed to the outlet opening of the end plate.

5. The fluid filter as in claim 4, wherein the neck portion has a length sufficient to define a gap between a shield portion of the end disk and a portion of the end plate the includes the inlet openings.

6. The fluid filter as in claim 5, wherein a wall portion depends away from the shield portion and the fluid filtration path passes between the wall portion and an inner surface of the housing.

7. A fluid filter, comprising:
a housing defining an inner cavity;
an end plate secured to the housing, the end plate having a plurality of inlet openings and at least one outlet opening;
an inner sleeve disposed within the housing, the inner sleeve having portions in a spaced relationship with respect to the end plate and an interior surface of the housing;
a plurality of tab members extending away from the inner sleeve, the tab members contacting a portion of the housing and defining a fluid path between the interior surface of the housing and an interior area of the inner sleeve, the interior area being in fluid communication with the at least one outlet opening;
a filtration media disposed within the interior area of the inner sleeve, wherein a fluid filtration path from the inlet openings to the at least one outlet opening is defined by the inner sleeve and the filtration media is disposed in the fluid filtration path.

8. The fluid filter as in claim 7, wherein the filtration media comprises a first layer of filtration media, the first layer of filtration media being thermoformed to have a plurality of channels with an upper surface and a lower surface; a second layer of filtration media, the second layer of filtration media being secured to the lower surface of the first layer to form a plurality of inlet openings at one end of the first and second layers of filtration media and a sealed outlet disposed at another end of the first and second layers of filtration media, the another end comprising a substantially flat configuration; and a strip of adhesive disposed on the upper surface of the first layer, wherein the second layer is secured to the first layer by the strip of adhesive as the first and second layers are wrapped about each other and fluid flowing into the inlet openings and out the at least one outlet opening must pass through the filtration media.

9. The fluid filter as in claim 7, wherein the inner sleeve has a neck portion fluidly sealed to the at least one outlet opening of the end plate.

10. The fluid filter as in claim 9, wherein the neck portion has a length sufficient to define a gap between a shield portion of the inner sleeve and a portion of the end plate which includes the inlet openings.

11. The fluid filter as in claim 10, wherein a wall portion depends away from the shield portion, the wall portion defining a portion of the fluid filtration path between an outer surface of the wall portion and an inner surface of the housing.

12. The fluid filter as in claim 11, wherein the plurality of tab portions depend away from the wall portion and the plurality of tab portions define a plurality of openings.

13. A fluid filter, comprising:
a housing defining an inner cavity;
an inner sleeve disposed within the inner cavity, the inner sleeve having portions in a spaced relationship with respect to an interior surface of the housing;
a plurality of tab members extending away from the inner sleeve, the tab members contacting a portion of the housing and defining a fluid path between the interior surface of the housing and an interior area of the inner sleeve, the interior area being in fluid communication with at least one outlet opening of the inner sleeve; and
a filtration media disposed within the interior area of the inner sleeve, wherein a fluid filtration path to the at least one outlet opening is defined by the inner sleeve and the filtration media is disposed in the inner sleeve.

14. A fluid filter as in claim 13, wherein the at least one outlet opening of the inner sleeve and the housing is configured to be secured to a flange.

15. The fluid filter as in claim 13, wherein the filtration media comprises a first layer of filtration media, the first layer of filtration media being thermoformed to have a plurality of channels with an upper surface and a lower surface; a second layer of filtration media, the second layer of filtration media being secured to the lower surface of the first layer to form a plurality of inlet openings at one end of the first and second layers of filtration media and a sealed outlet disposed at another end of the first and second layers of filtration media, the another end comprising a substantially flat configuration; and a strip of adhesive disposed on the upper surface of the first layer, wherein the second layer is secured to the first layer by the strip of adhesive as the first and second layers are wrapped about each other.

16. The fluid filter as in claim 13, wherein a shield portion of the inner sleeve is configured to define a gap between the shield portion of the inner sleeve and the filtration media.

17. The fluid filter as in claim 13, wherein the plurality of tab members each have a feature for releasably engaging a complimentary feature of the housing.

18. The fluid filter as in claim 13, wherein the housing has an open end and a shield portion of the inner sleeve is received within the open end and a peripheral edge of the shield portion defines a gap between the inner sleeve and an inner surface of the housing, the gap defining a fluid path between the inner sleeve and the inner surface of the housing.

19. The fluid filter as in claim 18, wherein a wall portion depends away from the shield portion, the wall portion defining a portion of a fluid filtration path between an outer surface of the wall portion and the inner surface of the housing.

20. The fluid filter as in claim 19, wherein the wall portion further comprises a plurality of openings providing fluid communication to the filtration media.
